(19) United States
(12) Patent Application Publication
(10) Pub. No.: US 2018/0185851 A1
(43) Pub. Date: Jul. 5, 2018

(54) Method and Installation Configuration for Preparing and Activating a Raw Material

(71) Applicant: Loesche GmbH, Duesseldorf (DE)

(72) Inventors: Holger WULFERT, Duesseldorf (DE); Horst-Michael LUDWIG, Duesseldorf (DE); André BÄTZ, Duesseldorf (DE); Winifried RUHKAMP, Duesseldorf (DE); Markus JANSSEN, Duesseldorf (DE)

(73) Assignee: Loesche GmbH, Duesseldorf (DE)

(21) Appl. No.: 15/741,015

(22) PCT Filed: Jul. 16, 2015
(86) PCT No.: PCT/EP2015/066348

§ 371 Date: Dec. 29, 2017

(51) Int. Cl. B02C 15/00; B02C 23/12; B02C 23/14; B02C 23/30; C04B 7/52; C22B 7/04

(52) U.S. Cl. CPC B02C 15/007; B02C 23/12; B02C 23/14; B02C 2015/002; C04B 7/52; C22B 7/04; B02C 23/30

(57) ABSTRACT

The invention relates to a method for preparing and activating a raw material, wherein the raw material is comminuted by means of grinding rollers in a mill-classifier combination, and wherein the mill-classifier combination is set and operated to produce a ground product with a fineness of between D50=3 μm and D50=12 μm. Here, a part of the grinding product is comminuted by means of the mill-classifier combination to a diameter of <5 μm. Subsequently the ground product is subjected to a further classification in an ultrafine grain classifier unit which has a separation threshold in order to separate ultrafine grain with a fineness of <D50=6 μm. The invention further relates to an installation configuration for carrying out the method according to the invention.

The invention relates to a method for preparing and activating a raw material which has latently hydraulic, hydraulic, inert or pozzolanic properties. The invention further relates to an installation configuration for carrying out this method.

Methods are known for preparing a raw material, wherein the raw material is comminuted by means of grinding rollers of a mill-classifier combination. Here, the mill-classifier combination has a classifier and a vertical mill, wherein the vertical mill has a grinding pan and a plurality of grinding rollers. The mill-classifier combination is set and operated to produce a ground product from the raw material fed to the mill-classifier combination with a fineness of between D50=3 μm and D50=12 μm. Here, raw material which has been comminuted at least once by means of the grinding rollers in a first classification is fed back from the classifier of the mill-classifier combination as rejected coarse material, which is also called oversize material, to the grinding pan of the vertical mill for further comminution by means of the grinding rollers.

To carry out the generic method, installation configurations for preparing a raw material are known which have a mill-classifier combination. Here, the mill-classifier combination has a classifier and a vertical mill, which in turn has a grinding pan and a plurality of grinding rollers, which are preferably arranged lying opposite and in pairs. The mill-classifier combination is designed to comminute the raw material to a fineness of between D50=3 μm and D50=12 μm as a ground product by means of the grinding rollers.

Furthermore the mill-classifier combination is configured so that raw material comminuted at least once by means of the grinding rollers in a first classification is fed back from the classifier of the mill-classifier combination as rejected coarse material to the grinding pan of the vertical mill for further comminution by means of the grinding rollers.

A similar method is known for example from EP 0 696 558 A1. This method is used to produce an ultrafine cement-binder mixture. Here, clinker is ground by means of a ball mill until it has the required fineness. The same is also described therein for granulated slag in order to produce granulated slag ultrafine powder. The method and the corresponding installation do indeed make it possible to produce ultrafine ground clinker and granulated slag, but at significantly increased costs in comparison with the production costs of normal cement.

Rapidly cooled and vitreous-hardened blast furnace slag is referred to as granulated slag. It is thus a by-product from raw iron production in the blast furnace. Comminuted granulated slag has already been used for over 100 years as a constituent part of composite cements. Composite cements are cements which have, besides the main constituent part Portland cement clinker, one or more further main constituent parts. Composite materials as a further main constituent part in cement have in the meantime been used, inter alia, with the aim of reducing CO₂ emissions, since significantly lower CO₂ emissions arise in the production of the composite materials in comparison with the production of Portland clinker. An example of a composite material is granulated slag.

Besides blast furnace slag from raw iron production, steelworks slag, inter alia, arises in steel production. This is also described as LD slag, as it comes from the melt according to the Linz-Donawitz method. It is also referred to as BOF slag (basic oxygen furnace). LD slag has a content of clinker phases which could in principle also be considered for a use as composite material in composite cements. For example, between 3 mass % and 8 mass % alite (C₃S, tricalcium silicate) and between 18 mass % and 26 mass % belite (C₂S, dicalcium silicate) are present. Also the glass phase contained therein of 5 mass % to 40 mass % can be regarded as potentially reactive. However, it has not yet been managed to prepare LD slag in such a way that the hydraulic properties of the clinker and glass phases present therein can be used. For this reason, LD slag is not used at the present time—unlike granulated slag—as a main constituent part in cement but merely as filler in road construction and to a low extent also as fertiliser. Depending upon further additives, however, it is no longer possible due to more recent regulations to continue this use. This is leading to an increasing disposal of the LD slag. However, the disposal is problematic due to current EU environmental regulations, since disposal is also already no longer permitted in part as a result of the required environment standards.

It is the object of the invention to indicate a method and an installation configuration for preparing and activating a raw material which has latently hydraulic, hydraulic, inert or pozzolanic properties, which can be realised efficiently and cost-effectively. This also relates to the preparation and activation of LD slag not used up to now for cements.

This object is achieved according to the invention by a method for preparing and activating a raw material having the features of claim 1 and by an installation configuration for preparing and activating the raw material having the features of claim 12.

Advantageous embodiments of the invention are indicated in the sub-claims and the description as well as in the figures and the explanation thereof.

In the method according to the invention, in the normal grinding process a part of the grinding product is comminuted by means of the grinding rollers to a diameter of <5 μm, wherein, in the case of a raw material with potentially reactive properties, existing pozzolanic, latently hydraulic or hydraulic active phases are released. After the comminution and the first classification in the mill-grinder combination, the ground product is subjected to a further classification into fine and ultrafine grain in an ultrafine grain classifier unit.

The ultrafine grain classifier unit is operated and set with a separation threshold in order to separate from the ground product ultrafine grain with a fineness of less than D50=6 μm. The fine grain is removed from the preparation process after the classification in the ultrafine grain classifier unit and can be supplied for a building material application. The ultrafine grain is fed to a filter after the second classification.

This takes place by means of a process air flow which is guided from the mill-classifier combination via the ultrafine grain classifier unit to the filter. By means of the filter the ultrafine grain is separated from the process air flow and can then be supplied for use as a composite material in cement, wherein, in the ultrafine grain in the case of a raw material with potentially reactive properties, at least a part of the pozzolanic, latently hydraulic or hydraulically active phase is activated by the release and/or an increased overall reactivity is achieved by the significantly increased particle surface area.

According to the meaning of the invention a raw material with hydraulic properties is used to denote a raw material which, together with water, hardens, and is watertight after hardening. An example of this is Portland cement clinker, wherein the cement phases alite and belite ensure hardening. Raw materials with latently hydraulic properties also harden when water is added, but only if at the start of the reaction for example an alkaline or sulphate stimulant is present. Granulated slag is for example a raw material with latently hydraulic properties.

A raw material with inert properties within the scope of the invention is a raw material which is largely uninvolved in the reactions with water. Limestone for example constitutes an inert composite material. Furthermore a raw material with pozzolanic properties is regarded within the scope of the invention as a raw material which reacts with water to form strengthening hydrate phases if calcium hydroxide is permanently available as a reaction partner. Hard coal fly ash is a typical example for pozzolanic substances. According to the meaning of the invention the term “raw material with potentially reactive properties” can be understood in that the raw material has a potential for pozzolanic, latently hydraulic or also hydraulic properties. Correspondingly, according to the meaning of the invention a potentially hydraulic raw material, for example, is also a raw material which does in principle have the potential to be hydraulic, as it has alite for example, but it has not yet been possible to use or activate this property.

The activation of a raw material with potentially reactive properties according to the meaning of the invention can be understood in that by processing or treating the raw material the potentially reactive phases are manipulated so that they provide a significant contribution to strength in the composite cement.

The method according to the invention uses a mill-classifier combination which has a classifier and a vertical mill. The vertical mill itself has a plurality of coupled grinding rollers, mostly arranged in pairs lying opposite and which roll on a grinding pan. The raw material to be ground or comminuted is fed to the vertical mill and arrives on the rotating grinding pan, on which it forms a grinding bed. On this grinding bed the grinding rollers, which are arranged in a stationary way and are designed to be rotatable, roll and thus comminute the raw material supplied which is also described as grinding material.

Different operating modes are known for a mill-classifier combination. On the one hand it can be operated as an overflow mill, wherein comminuted grinding material drops down from the grinding pan due to gravity and is then fed by a conveying means to a classifier. On the other hand an operating mode as an air-swept mill is known, in which at least partially comminuted grinding material overflowing from the grinding pan is conveyed upwards by an air flow in the direction of the classifier arranged above the grinding pan. However, grinding methods are also known, in which the two operating modes are connected.

A first classification takes place in the classifier of the mill-classifier combination. Here, grinding material that has not yet been comminuted to be small enough, which has normally been comminuted at least once already by the grinding rollers and thus constitutes once comminuted raw material, is rejected in the classifier as coarse material, which is also described as oversize material, and fed to the grinding pan of the vertical mill for a further comminution. Already sufficiently comminuted raw material is discharged from the treatment and processing in the mill-classifier combination.

The invention is based on the basic idea that the use of a vertical mill, in particular a vertical roller mill, for example of the LOESCHE type, is advantageous for the production of ultrafine grain with a fineness of less than D50=6 μm and a subsequent second classification after the classification required for the grinding.

The invention is based on the recognition that when using vertical mills in a mill-classifier combination it is possible in a relatively cost-effective manner to produce a ground product with a fineness of between D50=3 μm and D50=12 μm. The production of a ground product with such fineness requires a significantly lower amount of energy, in particular in comparison with conventional methods with ball mills. During the operation of a mill-classifier combination to produce a ground product with the above-indicated fineness, a non-negligible proportion of the raw material can also be comminuted so that it has a diameter of <5 μm. This portion of the product then has a fineness like conventional, ultrafine comminuted materials such as for example ultrafine clinker or ultrafine granulated slag.

This diversification is exploited in the invention by separating from the grinding product, which in principle overall is not particularly finely ground in comparison with ultrafine cement, a portion which has the necessary fineness for ultrafine ground materials.

This separation is carried out according to the invention in an ultrafine grain classifier unit in the sense of a second classification of the grinding product.

In terms of method, the grinding product is conveyed from the mill-classifier combination via the ultrafine classifier unit to a subsequent filter by means of a process air flow. In the filter the ultrafine grain, which has not been separated in the ultrafine grain classifier unit, is then separated from the process air flow.

The product after the ultrafine grain classifier unit is the material separated from this, a product as fine grain. This has a particle size distribution of more than D50 =8 μm and is referred to below as fine grain or fine material. The material separated in the filter has a fineness of less than D50=6 μm and thus contains a large part of the material which has been comminuted in the mill-classifier combination to a diameter of <5 μm. This material is described below as ultrafine grain or ultrafine material.

It is thus possible with the method according to the invention, without additional workload being necessary, to produce a fine grain product and an ultrafine grain product which can both be fed separately for an application, for example in the building materials industry.

In the grinding of Portland cement clinker, conventional clinker can thus be produced as fine grain and additionally ultrafine ground clinker as ultrafine grain without additional work steps being necessary. By using a vertical roller mill this can be achieved without substantially increased energy consumption in comparison with the normal production of ground cement clinker. This also applies to the grinding of other hydraulic, latently hydraulic, inert or pozzolanic raw materials such as for example granulated slag, fly ash, calcined clay or limestone.

A further recognition of the invention results from the specific properties of potentially latently hydraulic or potentially hydraulic raw materials such as LD slag. These have, as already described, in principle reactive phases (alite, belite, glass phase). However, it has not yet been possible to activate these potentially reactive phases. This means, it was not yet known how LD slag must be subsequently processed or treated in order that the potentially reactive properties can be activated.

It was recognised within the scope of the invention that the clinker phases of interest for hydraulicity, namely alite and belite and glass phase(s), in the LD slag are mostly overgrown by wustite and/or other non-reactive or less reactive phases. Through the ultrafine grinding by means of the method according to the invention it is ensured that the clinker and glass phase(s) of interest for hydraulicity are released. This release and the high degree of fineness of these phases due to the ultrafine grinding lead to the LD slag providing, when combined with water, a significant independent strength contribution. LD slag, which has up to now been used as low-quality material, can now also be used as composite material in cement, as at least a part of the potentially reactive phases are activated by the release. This means that LD slag ultrafine grain can be used in the cement industry as a high-quality composite material.

In the comminution of Portland cement clinker there is the advantage that an increased overall activity can be achieved with the ultrafine grain product, in comparison with the fine grain product, through the significantly increased total particle surface area. The significantly increased particle surface area also has the effect with raw materials other than Portland cement clinker that an increased overall activity can be achieved in the ultrafine grain product. From a monetary viewpoint this results in the possibility of raw materials and cements from this ultrafine grinding being offered at significantly higher prices, as they have a higher performance capacity.

The D50 value describes the particle size distribution in a grain distribution, wherein 50 mass % is greater and 50 mass % is smaller than the indicated diameter of the threshold grain. In particular, it has been shown with the degrees of fineness present here that this variable is better suited than the usual specific surface according to Blaine.

By means of the method according to the invention therefore conventional comminuted clinker can be obtained for example in the preparation of Portland cement clinker and as a second product ultrafine clinker can be obtained for a high-quality use as special cement. Similarly, when using granulated slag as a raw material, on the one hand conventionally comminuted granulated slag can be produced but additionally also ultrafine comminuted granulated slag, which can be used as a high-quality concrete additive or cement composite material.

Multi-composite cements of higher performance capacity can also be produced by the method according to the invention. Fine and ultrafine fractions can be produced from different composite materials such as granulated slag, fly ash, limestone powder, and from cement clinker, and mixed together so that, with respect to different performance criteria such as processability, strength and/or longevity, an ideal grain size distribution is produced. The fine and ultrafine grinding of limestone powders likewise leads to high-quality binders and cements. The fine fraction can be used to produce high-performance Portland limestone cements or limestone-containing multi-composite cements, while the ultrafine fraction can be used as heterogeneous nucleators for more rapid cements and concretes.

In principle the ultrafine grain classifier unit can be operated and set with an arbitrary separation threshold. It has proved advantageous, however, if this threshold is preferably set so that, after the filter, 10% to 20% of the mass of the raw material can be separated from the process air flow as ultrafine grain. The range of 10% to 20% of the mass of the raw material is thus advantageous as approximately 5% to 10% of the raw material is comminuted by the grinding rollers to a diameter of <5 μm, and the ultrafine grain can have a particle size distribution of less than D50=6 μm.

In principle it would also be possible to increase the percentage portion of the ultrafine grain. However, this would lead to the raw material or the grinding material having to be more greatly comminuted in the mill-classifier combination, which in turn would result in a significantly increased energy requirement. In a range of from 10 mass % to 20 mass % of the raw material as ultrafine grain, the production of the ultrafine grain can be carried out substantially without increased energy resources in the mill-classifier combination, whereby precisely the advantages of the method according to the invention are illustrated.

Cyclone arrangements or a plurality of ultrafine classifiers connected in parallel can be used as an ultrafine grain classifier unit. In particular multi-cyclones or also cyclone packs can be used as cyclone arrangements.

Cyclones are also described as centrifugal force separators. An advantage in the use of cyclone arrangements is that these do not have any moving parts in comparison with dynamic classifiers. In addition they have a good separation capability and are relatively easy to control.

The method according to the invention has proved advantageous in the use of raw materials, of which reactive constituent parts are overgrown by non-reactive or only slightly reactive constituent parts and which therefore initially have no distinct hardening capacity with water. LD slag can be mentioned as an example here. This disadvantage can be overcome by the method according to the invention. This is in particular due to the fact that, as already described, it was recognised that with these raw materials the conventionally non-accessible, potentially reactive phases can be released by the ultrafine grinding. When released, they can provide a significant strength contribution for use in cement, so that these raw materials can also be used in the future as the main constituent part in cement.

In principle the grinding of the raw material can take place in the mill-classifier combination without the addition of further materials. It has proved advantageous, however, if grinding aids are added which, for example, reduce the energy requirements during grinding and/or bring about a chemical activation of the hydraulic phases. Here, for example amine-containing grinding aids with and without a low proportion of chloride-containing salts can be used. Examples are the two grinding aids LS 3116 and ES 2168 from the MasterCem-product series by BASF.

With such grinding aids the grinding can be optimised in terms of energy. In addition, by adding amines the hydration of the ultrafine grain but also of the fine grain is stimulated when using LD slag ultrafine grain. An advantage precisely in the production of ultrafine grain from steelwork slag is that this, unlike other cement components, does not introduce any chloride into the cement. Grinding aids can therefore also be used which contain low amounts of chloride-containing salts without jeopardising compliance with the threshold value of 0.1 mass % chloride in the cement.

It is preferable if the fine grain is removed from the ultrafine grain classifier unit via a means which at least limits a false air entry into the process air flow. For example, for this, one or more rotary air locks can be used. A false air entry into the ultrafine grain classifier unit, in particular if a cyclone arrangement is used, is undesirable, as this influences the separation capability and the separation threshold of the fine grain classifier unit. In addition the total amount of process air flow would thus increase, which would then lead to an increased need for regulation of the whole installation configuration.

When using cyclone arrangements as an ultrafine grain classifier unit the separation threshold between fine and ultrafine grain can be influenced for example by the flow speed in the cyclones of the cyclone arrangements. An increase in the flow speed in a cyclone leads to an increase in the fineness of the ultrafine grain. Vice versa, a reduction in the flow speed in a cyclone leads to a reduction of the fineness of the ultrafine grain.

The flow speed in the cyclones can be increased for example by increasing the total amount of process air flow and/or reducing the number of active cyclones of the cyclone arrangements. Through the overall increase in the amount of process air flow, which passes from the mill-classifier combination via the cyclone arrangements to the filter, this can be realised relatively easily. For this, in particular a regulation of the mill fan or a fan for the process air flow can be used.

A reduction in the number of the active cyclones leads to the existing amount of process air flow being conveyed through fewer cyclones. This results in the flow speed in the less active cyclones therefore having to be increased.

In another possibility that can be used additionally or alternatively thereto, the amount of process air flow in the region of the cyclone arrangements arises by recirculating a part of the process air from downstream of the filter and feeding the branched-off portion of the process air upstream of the cyclone arrangements.

In principle, it is also conceivable to feed fresh air into the process air flow upstream of the cyclone arrangements in order to increase the amount of process air flow. In principle the supply of the fresh air or the branched-off process air can take place at any point upstream of the cyclone arrangements. It is advantageous if this takes place shortly before the cyclone arrangements, as otherwise in some areas an unnecessarily large amount of process air is transported, which in turn would have to be considered in the configuration of the cross-sections of the pipes.

In order to reduce the flow speed in the cyclones of the cyclone arrangements, different methods can be used. It is possible for example to reduce the flow speed by reducing the total amount of process air flow. For this, existing fans, for example the mill fan(s), can be used and correspondingly controlled. A further possibility is to increase the number of active cyclones of the cyclone arrangements. The existing amount of process air flow must be divided here through a plurality of cyclones, in particular connected in parallel, so that overall for each cyclone a lower amount of process air flow is present, which leads to a lower flow speed.

Another possibility is to purposefully feed funnel air into the cyclones of the cyclone arrangements, whereby the flow speed is likewise lowered. The feeding of funnel air reduces the speed of the swirl in the centre of a cyclone, with the result that the separation threshold is displaced into the coarse portion. It is to be ensured here, however, with effect from an approximately 20% proportion of the funnel air in the total process air flow through a cyclone, that a sufficient separation no longer takes place in the cyclone.

It is also possible to reduce the amount of process air in the cyclones of the cyclone arrangements by deflecting a part of the process air from upstream of the cyclone arrangements and feeding the part of the process air downstream of the cyclone arrangements. A part of the process air is thus guided past the cyclone arrangements in a bypass.

The method according to the invention can preferably be carried out with an installation configuration which has a mill-classifier combination. The mill-classifier combination has a classifier and a vertical mill, which in turn has at least one grinding pan and a plurality of, in particular stationary and rotatably arranged, grinding rollers. The mill-classifier combination is designed to comminute the raw material to a fineness of between D50=3 μm and D50=12 μm as a grinding product by means of the grinding rollers. Here, the mill-classifier combination is designed in order to feed raw material comminuted at least once by means of the grinding rollers in a first classification from the classifier of the mill-classifier combination as rejected coarse material back to the grinding pan of the vertical mill for further comminution by means of the grinding rollers.

According to the invention the mill-classifier combination is designed so that a part of the grinding product is hereby comminuted to a diameter of <5 μm, wherein, in the case of a raw material with potentially reactive properties, pozzolanic, latently hydraulic or hydraulic phases are released. Furthermore an ultrafine grain classifier unit and a filter are provided. A guided process air flow leads from the mill-classifier combination via the ultrafine grain classifier unit to the filter and is designed to transport the raw material comminuted in the mill-classifier combination. Here, the ultrafine grain classifier unit is configured to classify the grinding product in a further classification into a fine and an ultrafine grain. The ultrafine grain classifier unit can be set and operated at a separation threshold in order to separate the ultrafine grain with a fineness of less than D50=6 μm. The filter is designed to separate ultrafine grain from the process air flow from the ultrafine grain classifier unit.

A core idea of the installation configuration according to the invention can be seen in that it has been recognised that it is not necessary, for the production of a product as ultrafine grain, to prepare and comminute all the raw material as ultrafine grain. It is provided corresponding to the invention to comminute a part of the raw material as fine grain and merely to comminute a smaller part in such a way that it can be further used as ultrafine grain. It is ensured in this way that significantly less energy needs to be used in order to produce ultrafine grain than if all the raw material were comminuted to ultrafine grain. In this connection, the use of a vertical mill, in particular a vertical roller mill for example of the LOESCHE type, has proved advantageous, as this comminutes, in the case of a, for example, desired product fineness after the mill-classifier combination of between D50=3 μm and D50=12 μm, a part of the grinding product to a diameter of <5 μm. If this part of the grinding product with the diameter of <5 μm is separated in a second classification, which is carried out by means of the ultrafine grain classifier unit, from the rest of the comminuted grinding product, a product can be produced as an ultrafine grain product without great further expense.

It is advantageous here that for this ultrafine grain product, available additionally besides the conventional fine grain product, essentially no additional energy is required for the grinding. In other words: a second product can be produced with a hardly modified conventional grinding and comminution method and a corresponding installation, the second product being even higher-quality than the first product in the fine grain size.

Cyclone arrangements or a plurality of ultrafine classifiers, in particular connected in parallel, can be used as an ultrafine grain classifier unit. The cyclone arrangements used can be in particular multi-cyclones or cyclone packs with a diameter of maximum 700 mm, preferably in the range of from 200 mm to 500 mm. In particular the use of cyclone arrangements is advantageous, as these do not have any, or hardly any, moving parts and are thus relatively low-maintenance. In addition, cyclones have a good separating capability and are easy to control.

It is preferable if the ultrafine grain classifier unit has a means to remove the separated fine grain, which at least limits a false air entry into the process air flow. For this, for example, one or a plurality of rotary air locks is/are used. In particular when using cyclone arrangements, a false air entry is undesirable, as this would influence the separation threshold in the cyclone arrangements. On the other hand it is also undesirable to feed additional false air into the process air flow, as the amount of process air flow, which is a relevant control variable, is hereby increased. This would in turn lead to necessary readjustments.

Controllable process gas recirculation pipes are advantageously provided from downstream of the filter to upstream of the cyclone arrangements. These recirculation pipes can be used to influence the amount of process air flow which flows through the cyclone arrangements. By means of the amount of process air flow the separation threshold between fine grain and ultrafine grain can be influenced in cyclone arrangements.

In addition, a bypass line from, in particular directly, upstream of the cyclone arrangements to downstream of the cyclone arrangements can be provided. This bypass line can also be used to influence the amount of process air flow which flows through the cyclone arrangements by process air being guided past the cyclone arrangements.

The invention will be described in greater detail below using a schematic exemplary embodiment by reference to the further figures, in which:

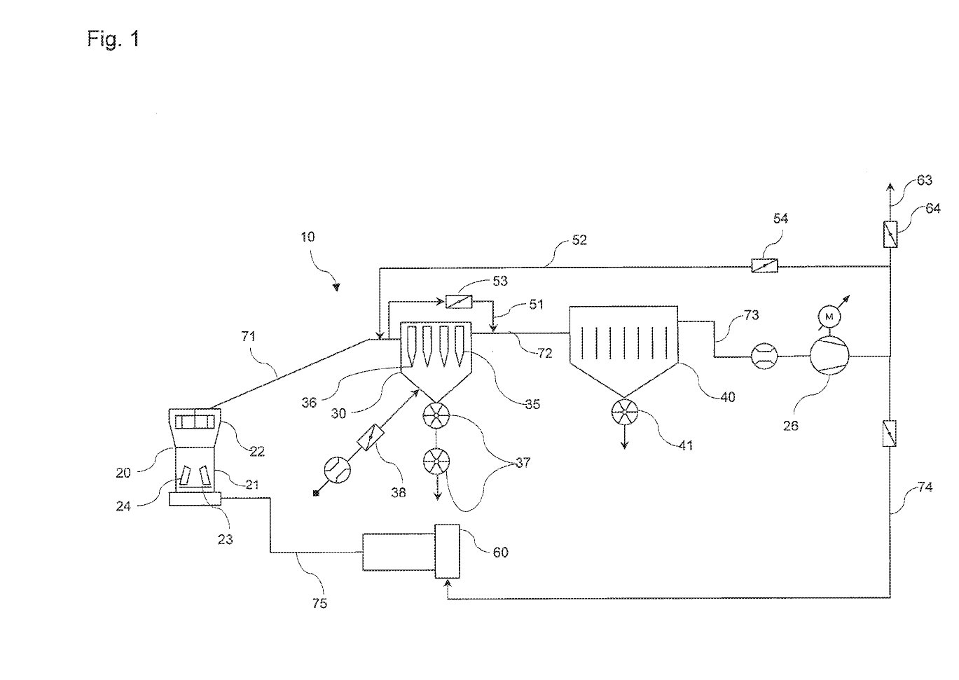

FIG. 1 shows a schematic flowchart of an installation configuration according to the invention;

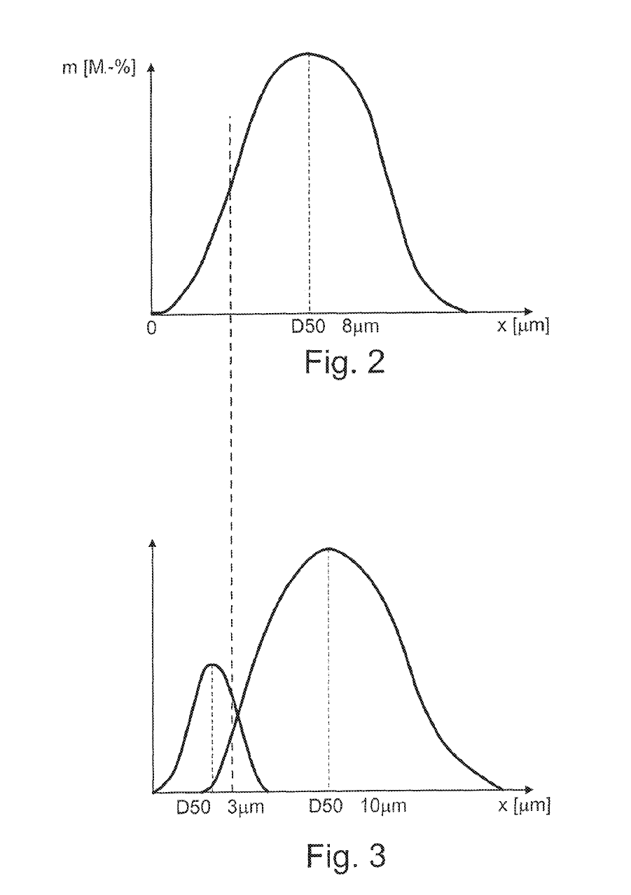

FIG. 2 shows a simplified grain size distribution after a mill-classifier combination;

FIG. 3 shows a simplified grain size distribution after an ultrafine grain classifier unit;

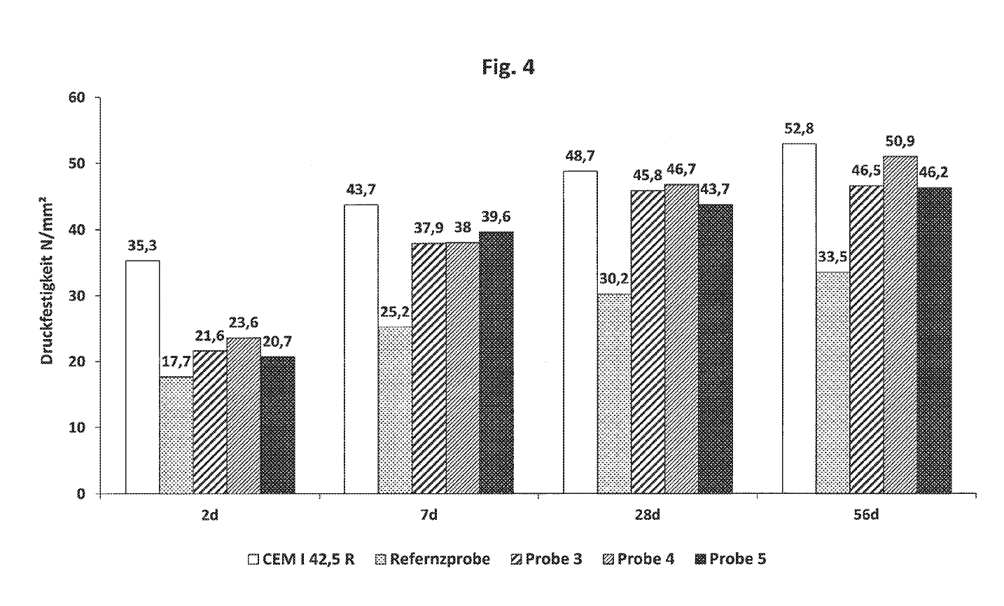

FIG. 4 shows a diagram for strength studies of ultrafine ground LD slag; and

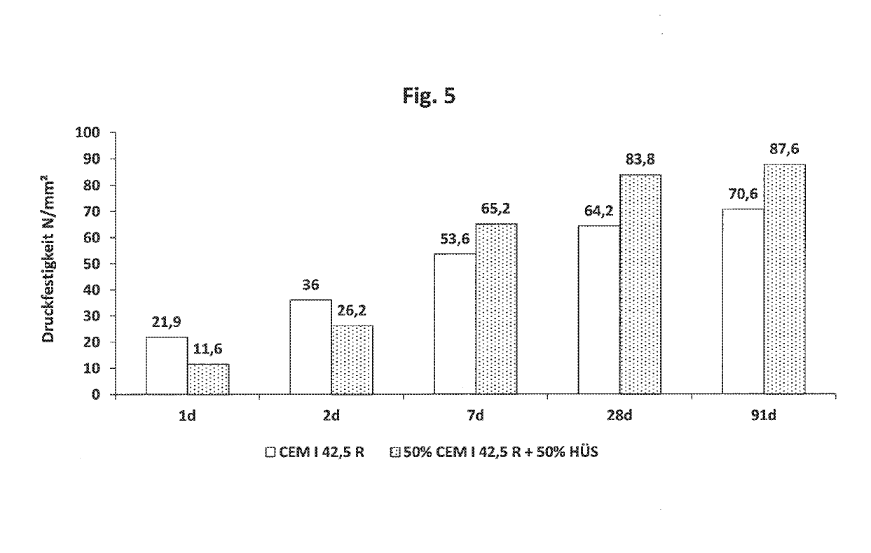

FIG. 5 shows a diagram for strength studies of ultrafine ground granulated slag.

FIG. 1 shows a flowchart of an installation configuration 10 according to the invention in a schematic form. The installation configuration 10 has as essential elements a mill-classifier combination 20, an ultrafine grain classifier unit 30 and also a filter 40.

The mill-classifier combination 20 consists of a vertical mill 21 and a classifier 22. The vertical mill 21 has a driven grinding pan 23 and a plurality of grinding rollers 24 which are arranged to be stationary and designed to be rotatable. During the grinding process, a grinding bed is formed on the grinding pan 23 by means of the grinding material supplied, on which grinding bed the grinding rollers 24 roll and thus comminute the grinding material.

Subsequently the comminuted grinding material is conveyed by means of an air flow to the classifier 22. A classification of the grinding material into coarse and fine grain takes place in said classifier 22. Coarse material is rejected by the classifier 22 and conveyed back to the grinding pan 23 of the vertical mill 21 for a further overgrinding.

Here, the mill-classifier combination 20 can in principle be operated both as an overflow mill and also as an air-swept mill. In the embodiment shown here, the mill-classifier combination 20 is configured as an air-swept mill.

To transport the comminuted grinding material, which can also be described as grinding product, different pipelines are provided. A first pipeline 71 leads from the mill-classifier combination 20 to the ultrafine grain classifier unit 30. From there, a second pipe line 72 leads to the filter 40. A further pipeline 73 leads to a T junction, which leads on the one hand to a flue 63 and on the other hand to a fourth pipeline 74. The fourth pipeline 74 leads to a hot gas generator 60 which is used to heat process gas in order to also carry out drying during the grinding. The process gas heated by the hot gas generator 60 is conveyed via a fifth pipeline 75 back to the mill-classifier combination 20.

Through the process gas flow, which flows through the mill-classifier combination 20, the grinding product not rejected by the classifier 22 is conveyed via the first pipe 71 to the ultrafine grain classifier unit 30. The structure of the ultrafine grain classifier unit 30 is in principle arbitrary. In the embodiment shown schematically here, it is designed as a multi-cyclone 35 with a plurality of cyclones 36 arranged one after the other. Instead of a multi-cyclone 35, at this point a classifier especially suited for this task or a plurality of smaller ultrafine classifiers connected in parallel can also be used.

A further classification takes place in the multi-cyclone 35. Here, fine grain is separated from the ultrafine grain. The fine grain separated in the multi-cyclone 35 can subsequently be removed via rotary air locks 37 from the installation configuration 10 and supplied for use as a building material.

The ultrafine grain not separated in the multi-cyclone 35 is transported by means of the process air flow via the second pipeline 72 further to the filter 40. This can for example be a bag filter. The use of filter assemblies with a plurality of filters arranged one after the other is also possible.

In the filter 40 the ultrafine grain still in the process air flow is separated from this. The ultrafine grain can now be removed via an air lock 41 from the installation configuration 10.

The process air flow is guided from the filter 40 via the fourth pipeline 74 to the mill fan 26. By means of this mill fan 26 the flow speed of the process air flow can be adjusted. Subsequently to the mill fan 26, it is possible to expel a part of the process air flow via the flue 63. For this, a flue valve 64 is provided. Another part can be fed via a fourth pipeline 74 to the previously described hot gas generator 60, in which the process air of the process air flow is heated again. This heated process air is then fed via a fifth pipeline 75 back to the mill-classifier combination 20.

Further details will be set out below in relation to the fundamental recognition of the invention by reference to FIGS. 2 and 3. FIG. 2 shows a schematic grain size distribution after the mill-classifier combination 20 in the region of the first pipeline 71. FIG. 3 shows the grain size distribution of the ultrafine grain and the fine grain after the multi-cyclone 35. Both figures show greatly simplified, idealised grain size distributions.

Corresponding to the invention it has been recognised that when using a mill-classifier combination 20 which has a vertical mill 21 operated for example in order to produce a ground product with a fineness of between D50=3 μm and D50=12 μm, a grain size distribution as shown in FIG. 2 is present.

In the diagram in FIGS. 2 and 3 the diameter of a grain of the grinding product is recorded on the abscissa. The mass of the respective grain fraction in mass % is recorded on the ordinate.

As shown in FIG. 2, in the case of a fineness of D50=8 μm, 50% of the total mass of the ground product has a grain with a diameter of over 8 μm and 50% of the total mass of the grinding product has a grain size with a diameter of over 8 μm.

A grinding product with this particle size distribution is subsequently conveyed further for a second classification in the ultrafine grain classifier unit 30. In FIG. 3, the particle size distribution for the ultrafine grain is shown on the left side of the diagram and the particle size distribution for the fine grain on the right side of the diagram after the ultrafine grain classifier unit. As shown, here also, in dependence upon construction, there is no distinct separation between fine grain and ultrafine grain, but a smooth transition is present to a certain extent. The thus produced and classified ultrafine grain has in this example a fineness of D50=3 μm and the fine grain a fineness of D50=10 μm.

Through the second classification by means of an ultrafine grain classifier unit 30, which can for example be a cyclone pack, it is thus possible, in a normal grinding process with a mill-classifier combination 20, to also produce ultrafine grain without additional energy having to be expended for this for a particularly fine grinding.

As also follows from FIG. 3, the ratio between ultrafine grain and fine grain is approximately 10 to 20 mass % to 90 to 80 mass %.

When using multi-cyclones or a cyclone pack for the ultrafine grain classifier unit 30 there are different possibilities for setting the separation grain threshold. These are explained below in greater detail by reference to FIG. 1.

The separation grain threshold in the multi-cyclone 35 is determined substantially by the dimensions of the design of the individual cyclones of the multi-cyclone 36. However, it can be influenced in operation by the volume flow of the process air flow through each individual cyclone 36. The grain separation threshold is displaced in the direction of ultrafine grain if the flow speed is increased in the individual cyclones 36. There are different possibilities for this.

On the one hand the total amount of process air flow per time unit can be increased in the whole installation configuration 10. For this, it is possible to correspondingly control the mill fan 26.

On the other hand it is possible to increase the total amount of process air flow per time unit only in the region of the multi-cyclone 35. For this, a return gas line 52 can be provided which begins downstream of the filter 40 and ends upstream of the multi-cyclone 35. In addition, a control valve 55 is provided in the return gas line. By means of the return gas line 52 it is possible to convey process gas from behind the filter 40 or from behind the mill fan 26 to in front of the multi-cyclone 35 and thus to increase the amount of process gas air per time unit in the multi-cyclone 35. By means of the valve 54 the recirculated amount of process air can be regulated.

It is also possible to reduce the number of the active cyclones 36 in the multi-cyclone 35. As the amount of process air gas per time unit is not hereby changed, the flow speed within the active cyclone 36 increases. This in turn leads to a displacement of the separation threshold in the direction of ultrafine grain.

Similarly the separation threshold of the multi-cyclone 35 can also be displaced in the direction of the fine grain. For this, as previously similarly explained, by means of the mill fan 26 the amount of process air flow per time unit can be reduced. Another possibility is to activate or use more cyclones 36 of the multi-cyclone 35. Since this occurs with the same amount of process air per time unit, the respective flow speed in each cyclone 36 decreases.

Furthermore there is also the possibility of conveying funnel air via a regulating valve 38 into the individual cyclones 36. The flow speed also decreases here within the cyclone 36.

A further possibility is to provide a bypass line 51. This leads from upstream of the multi-cyclone 35 to directly downstream of the multi-cyclone 35. In addition a regulating valve 54 is provided. By means of the bypass line 51 it is possible to convey process gas from in front of the multi-cyclone 35 to behind the multi-cyclone 35 and thus reduce the amount of process gas per time unit in the multi-cyclone 35. By means of the valve 54 the amount of process air can be regulated.

In particular in the preparation of a potentially reactive raw material such as LD slag the method according to the invention has a further advantage. Conventionally LD slag could not be used as composite material in cement, as it does not contribute, or at least does not significantly contribute, to the strength.

Corresponding to the invention, however, it was recognised that clinker phases such as alite or belite in the range of from, in total, 20 mass % to 30 mass % and glass phase in the range of from 5 mass % to 40 mass % are present in LD slag. However, these phases are overgrown and are not freely accessible in the case of conventional grinding with a fineness of coarser than D50=8 μm.

Through the method according to the invention these phases are released in the ultrafine grain so that they can make a contribution to the strength when used in composite cement. For this, corresponding strength studies according to DIN EN 196 were carried out on standard prisms. The corresponding results are shown in FIG. 4.

The base cement or reference cement was CEM I 42.5 R. By way of reference specimen, 70 mass % reference cement was mixed with 30 mass % quartz sand and studied. The quartz sand is used as a non-reactive inert stone grain. In the third, fourth and fifth specimens, a mixture of 70 mass % reference cement with 30 mass % ultrafine grain from LD slag was studied. During the grinding of the specimen 3, no grinding aid was used. For the specimen 4, MasterCem ES 2168 was used as a grinding aid and for the specimen 5 MasterCem LS 3116 was used as a grinding aid, respectively of BASF.

As shown in FIG. 4, it follows from the studies that at the latest with effect from the seventh day the strength level of the specimens 3, 4 and 5 lies significantly above that of the reference specimen. It can be concluded from this that the LD slag provides its own contribution to strength in mixed cement at the latest after seven days.

Similarly, strength studies were also carried out for ultrafine ground granulated slag. In turn, CEM I 42.5 R was used as base cement. In the second specimen, in this case a 50:50 mixture of base cement and ultrafine ground granulated slag was studied.

The studies were carried out in turn corresponding to DIN EN 196 on standard mortar. As shown in FIG. 5, the studied mixture of base cement and ultrafine ground granulated slag in specimen 2 reaches a higher strength than the base cement already after the seventh day.

In summary, it can be stated that it is possible with the method according to the invention and the installation configuration according to the invention to produce composite material for use in cement without having to take substantially increased energy costs into account. Through the ultrafine grinding, even potentially reactive raw materials can be activated which have not been suited as cement composite material up to now.

1. Method for preparing and activating a raw material which has latently hydraulic, hydraulic, inert or pozzolanic properties,
wherein the raw material is comminuted by means of grinding rollers (24) of a mill-classifier combination (20),
wherein the mill-classifier combination (20) has a classifier (22) and a vertical mill (21) with a grinding pan (25) and with the grinding rollers (24),
wherein the mill-classifier combination (20) is set and operated to produce a ground product with a fineness of between D50=3 μm, and D50=12 μm, and
wherein in a first classification raw material comminuted at least once by means of the grinding rollers (24) in a first classification is fed from the classifier (22) of the mill-classifier combination (20) as rejected coarse material back to the grinding pan (25) of the vertical mill (21) for further comminution by means of the grinding rollers (24),
characterised in that
a part of the grinding product is comminuted by means of the grinding rollers (24) to a diameter of less than 5 μm, wherein in the case of a raw material with potentially reactive properties, existing pozzolanic, latently hydraulic or hydraulically active phases are released,
the grinding product is subjected to a further classification into fine and ultrafine grain in an ultrafine grain classifier unit (30),
the ultrafine grain classifier unit (30) is operated and set with a separation threshold in order to separate ultrafine grain with a fineness of less than D50=6 μm,
the fine grain is removed from the preparation process and supplied for a building materials application,
the ultrafine grain is fed to a filter (40),
wherein a process air flow is guided from the mill-classifier combination (20) via the ultrafine grain classifier unit (30) to the filter (40) and
the ultrafine grain is separated from the process air flow by means of the filter (40) and fed for a use as composite material in cement,
wherein in the ultrafine grain in the case of a raw material with potentially reactive properties at least a part of the pozzolanic, latently hydraulic or hydraulically active phases is activated by the release and/or an increased overall reactivity is achieved by the significantly increased particle surface area.

2. Method according to claim 1,
characterised in that
the ultrafine grain classifier unit (30) is operated and set with a separation threshold in order to separate, after the filter (40), 10% to 20% of the mass of the raw material as ultrafine grain from the process air flow.

3. Method according to claim 1 or 2,
characterised in that
cyclone arrangements such as multi-cyclones (35) or cyclone packs or a plurality of ultrafine classifiers connected in parallel, are used as an ultrafine grain classifier unit (30).

4. Method according to claims 1 to 3,
characterised in that
LD slags, fly ash or granulated slags are used as raw material.

5. Method according to one of claims 1 to 4,
characterised in that
grinding aids, in particular amine-containing grinding aids with or without a small proportion of chloride-containing salts, are added into the mill-classifier combination (20).

6. Method according to one of claims 1 to 5,
characterised in that
the fine grain is removed from the ultrafine grain classifier unit (30) via a means which at least limits a false air entry into the process air flow.

7. Method according to one of claims 1 to 6,
characterised in that
when using cyclone arrangements to increase the fineness of the ultrafine grain the flow speed in the cyclones (36) of the cyclone arrangements is increased.

8. Method according to claim 7,
characterised in that
the flow speed is increased by increasing the amount of process air flow and/or reducing the number of the active cyclones (36) of the cyclone arrangements.

9. Method according to claim 7,
characterised in that
the amount of process air flow is increased in the region of the cyclone arrangements by recirculating a part of the process air from downstream of the filter (40) and feeding the part of the process air to upstream of the cyclone arrangements.

10. Method according to one of claims 1 to 9,
characterised in that
when using cyclone arrangements to reduce the fineness of the ultrafine grain the flow speed in the cyclones (36) of the cyclone arrangements is reduced.

11. Method according to claim 10,
characterised in that
the flow speed is reduced by reducing the amount of process air flow, increasing the number of the active cyclones (36) of the cyclone arrangements, feeding funnel air into the cyclone (36) of the cyclone arrangements and/or by removing a part of the process air from upstream of the cyclone arrangements and feeding the part of the process air downstream of the cyclone arrangements.

12. Installation configuration (10) for preparing and activating a raw material which has latently hydraulic, hydraulic, inert or pozzolanic properties, having
a mill-classifier combination (20) which has a classifier (22) and a vertical mill (21) with a grinding pan (25) and grinding rollers (24),
wherein the mill-classifier combination (20) is designed to comminute the raw material to a fineness of between D50=3 μm and D50=12 μm as a grinding product by means of the grinding rollers (24),
wherein the mill-classifier combination (20) is designed in order to feed raw material comminuted at least once by means of the grinding rollers (24) in a first classification as rejected coarse material back to the grinding pan (25) of the vertical mill (21) for further comminution by means of the grinding rollers (24),
characterised in that
the mill-classifier combination (20) is designed to comminute a part of the grinding product to a diameter of <5 μm, wherein in the case of a raw material with potentially reactive properties, existing pozzolanic, latently hydraulic or hydraulically active phases are released,
an ultrafine grain classifier unit (30) and a filter (40) are provided,
a guided process air flow is provided from the mill-classifier combination (20) via the ultrafine grain classifier unit (30) to the filter (40) which is designed to transport the raw material comminuted in the mill-classifier combination (20),
the ultrafine grain classifier unit (30) is designed to classify the grinding product in a further classification into fine and ultrafine grain, the ultrafine grain classifier unit (30) can be set and operated at a separation threshold in order to separate ultrafine grain with a fineness of less than D50=6 μm, and
the filter (40) is designed to separate ultrafine grain from the process air flow coming from the ultrafine grain classifier unit.

13. Installation configuration according to claim 12,
characterised in that
cyclone arrangements such as multi-cyclones (35) or cyclone packs or a plurality of ultrafine classifiers connected in parallel are used as an ultrafine grain classifier unit (30).

14. Installation configuration according to claim 12 or 13,
characterised in that
the ultrafine grain classifier unit (30) has a means for removing the separated fine grain which at least limits a false air entry into the process air flow.

15. Installation configuration according to one of claims 12 to 14,
characterised in that
a controllable process gas recirculation line (52) is provided from downstream of the filter (40) to upstream of the cyclone arrangements.
